(19) United States
(12) Patent Application Publication
(10) Pub. No.: US 2010/0098573 A1
(43) Pub. Date: Apr. 22, 2010

(54) BOX-TYPE SINTERING CYCLE METHOD AND APPARATUS

(75) Inventor: Zhengfu Fan, Beijing (CN)

Correspondence Address: REISING ETHINGTON P.C., P O BOX 4390, TROY, MI, 48099-4390, US

(73) Assignee: Beijing STICH Science and Technology Company Ltd., Beijing (CN)

(21) Appl. No.: 12/580,653

(22) Filed: Oct. 16, 2009

(30) Foreign Application Priority Data
Oct. 17, 2008 (CN) 200810167253.5

(51) Int. Cl. B22F 3/10; C04B 35/64; B65G 47/52

(52) U.S. Cl. 419/1; 264/605; 198/346.1; 425/78

(57) ABSTRACT

The present disclosure relates to the sintering cycle method and apparatus of a kind of box-type sintering machine, which is peculiarly applicable to the production of lightweight aggregate using fly ash or industrial waste by sintering process. This apparatus includes four conveying systems, ignition station #1, ignition station #2, one tilt discharger, and one crusher; the box-type sintering stacking line A and B are straight and parallel, sharing one coarse dust collector; each box-type sintering stacking line is equipped with overhead workstation gantry crane rails and cranes, and each crane comprises two parts, i.e., hoist system and single rail trolley system; each box-type sintering stacking line has multiple sinter boxes; each sinter box has an air chamber below, under which there is the air chamber pipeline connected to the coarse dust collector. The present disclosure is a brand new cycle method and box-type sintering apparatus, resolving the long-standing issues of equipment waste and low efficiency associated with all sintering machines that return the empty sintering carts or boxes to the starting position following discharge, while also improving output efficiency, reducing the amount of equipment needed and related investment therein and considerably enhancing the reliability of system operation.

### CROSS-REFERENCE TO RELATED APPLICATION

This application claims the benefit of Peoples Republic of China Application No. 200810167258.5 filed Oct. 17, 2008, the disclosure of which is which is incorporated herein by reference in its entirety.

### TECHNICAL FIELD

The present disclosure relates to the cycle method and apparatus of a kind of box-type sintering machine, which is peculiarly applicable to the production of lightweight aggregate using fly ash or industrial waste by sintering process.

### BACKGROUND

The sintering technologies are widely used in the various industrial fields, e.g., in the metallurgical, building material, environmental protection industries and so on, to sinter the iron powder, raw metal ore, fly ash, clay, shale and others at certain temperature into the pellet with strength.

The traditional sintering machines include the strand sintering machines and step plane sintering machines. The structure of strand sintering machines is like a caterpillar, with two pairs of giant gearwheels in front and rear, i.e., head wheels and tail wheels. The strand sintering machines also include a burner system. The head wheels act as the drive wheels, and are controlled by the motor actuating the speed regulator. There are multiple sintering carts in the middle. The head wheels hoist the sintering carts from the cart return lines up onto the sintering lines one by one, and continuously accept the raw materials to be sintered. The number of sintering carts depends on the length of the sintering machine. The burner system is installed above the inlet of the sintering machine, and constantly keeps the high-temperature combustion. When each sintering cart filled with raw material enters the burner as driven by the head wheel, the high temperature inside the sintering hood will ignite the surface of the raw material in the sintering carts. The ignited sintering carts push forward one another on the straight line to the end of the sintering machine. As the sintering carts move, the lower air chamber inside the fully closed air box at the bottom of the sintering machine pulls down the high temperature inside the sintering carts, thus gradually igniting the other raw materials inside the sintering carts layer by layer, and achieving the effect of up-to-down combustion. The tail wheels dump the sintered materials in the sintering carts into the receiving hopper, and send the carts onto the cart return lines under the sintering machine. After this, the head wheels drive them up the sintering machine for cycle production, thus accomplishing a full process of sintering operation.

The step plane sintering machines have a cart pusher at the head of the sintering line. The cart pusher drives the several dozens of sintering carts on the sintering line, and travels in the length of one sintering cart, to discontinuously push the sintering carts to the head of the sintering machine one by one. After the full sintering process comprising charging, ignition, sintering and cooling at the end of the sintering machine, the sintering carts are turned over by the material dumper at the end of the sintering machine to dump the sintered materials into the receiving hopper, and then are sent onto the return track, on which the cart drive system conveys the sintering carts onto the transfer cart in the front of the sintering machine, which sends the sintering carts to their starting position. The sintering carts circularly move along the sintering line, material dumper track, cart return track, transfer cart in the front of the sintering machine on a rectangular plane, while the sintering carts move forward intermittently on the sintering line one by one as driven by the cart pusher in a discontinuous, stepped manner. It is required that the valve operation of the charging device shall be synchronous with the stepping frequency of the sintering carts.

The major issues associated with the traditional sintering machines are as follows. The strand sintering machines feature the high operating platform, high requirements for the factory building, heavy weight of equipment, and high-precision manufacturing and installation, which result in the high cost of production facility. Although the step plane sintering machines are lowered in overall height, the return system of their sintering carts is complicated and features low efficiency; they are not as compact as the strand sintering machines in terms of structure; the entire sintering system covers a bigger land area; a larger number of the empty sintering carts are needed after the sintering machine is discharged; the return structure is complicated and features low efficiency.

To address the above-mentioned issues, the inventor of the present application developed the “Method and apparatus for sintering ceramsite of fly ash” (Chinese invention patent application No. 200610002094.1, filing date is: Jan. 25, 2006) where the sinter boxes were used for circular sintering. That is, the sintering line was a closed circle loop. However, this equipment of production line needed multiple arc connections, which reduced the stability of equipment operation, and restricted the conveying capacity of the sinter boxes.

### SUMMARY

One exemplary embodiment of a box-type sintering cycle apparatus includes a plurality of sinter boxes arranged on box-type sintering stacking lines, with air chambers under the sinter boxes and an ignition system above the sintering stacking lines, wherein there are at least two parallel box-type sintering stacking lines, above which crane rails and cranes enable the sinter boxes to hoist and move. Above each of the parallel box-type sintering stacking lines is arranged a post-charging stacking position, a discharging position, a pre-ignition waiting position, a post-ignition stacking position, and multiple sintering positions, which are all arranged on a straight line, and the post-charging stacking position, discharging position, pre-ignition waiting position and post-ignition stacking position are located on the same end of the sintering stacking line or may be arranged at any locations on the sintering stacking lines. Above the parallel box-type sintering stacking lines are workstation gantry crane rails crossing all said positions, namely, the post-charging stacking position, discharging position, pre-ignition waiting position, post-ignition stacking position, and multiple sintering positions. Overhead workstation gantry cranes are adopted for conveyance of the sinter boxes along the sintering stacking lines. Multiple conveying systems are deployed for the sinter boxes transferring between the parallel box-type sintering stacking lines. The conveying systems are parallel to each other but vertical to the sintering stacking lines.

In accordance with another exemplary embodiment, there is provided a sintering cycle method for a box-type sintering machine including charging, ignition, sintering and discharging steps, wherein there are two parallel sintering stacking lines including a sintering stacking first line and a sintering stacking second line, with sinter boxes between both sintering stacking lines providing the following basic cyclic features. After charging and ignition on the first line, the sinter boxes of the first line transversely translate to the second line for sintering, and after the discharging is finished on the second line upon the sintering, the sinter boxes return to a discharging/charging position for charging next time. After charging and ignition on the second line, the sinter boxes of the second line transversely translate to the first line for sintering, and after the discharging is finished on the first line upon the sintering, the sinter boxes return to the discharging/charging position for charging next time, thus completing a cycle. The discharging/charging position is one selected from a first line discharging position, a second line discharging position, and first and second lines charging position.

### BRIEF DESCRIPTION OF DRAWINGS

Features and advantages of one or more of the disclosed embodiments of this disclosure will be apparent to those of ordinary skill in the art from the following detailed description of exemplary embodiments and the claims, with reference to the accompanying drawings in which:

FIG. 1 shows the layout of the equipment structure of the present disclosure.

FIG. 2 shows the front view of FIG. 1.

FIG. 3 shows the sinter boxes sintering cycle on line A and B described on FIG. 1.

FIG. 4 shows the cranes A and B working cycle described on FIG. 1.

### DETAILED DESCRIPTION OF EXEMPLARY EMBODIMENTS

### Reference Numbers of the Drawings

1—The box-type sintering stacking line A (abbrev: Line A or first line)
2—The box-type sintering stacking line B (abbrev: Line B or second line)
3A—Line A overhead workstation gantry cranes (abbrev: Crane A or first crane)
3B—Line B overhead workstation gantry cranes (abbrev: Crane B or second crane)
4A—Line A workstation gantry crane overhead rails (abbrev: Rail A or first rail)
4B—Line B workstation gantry crane overhead rails (abbrev: Rail B or second rail)
6A—Ignition station #1 or first ignition station
6B—Ignition station #2 or second ignition station
7—Discharging conveying system
7-1—Line A or first line discharging position
7-2—Line B or second line discharging position
8—Tilt discharger
8-1—Tilt discharging position
9—Crusher
10—Charging conveying systems
10-1—Line A or first line post-charging stacking position
10-2—Line B or second line post-charging stacking position
10-3—(Unsintered pellets) charging position
11—Ignition conveying system #1 or first ignition conveying system
11-1—Line A or first line post-ignition stacking position
11-2—Line B or second pre-ignition waiting position
11-3—Ignition position #1 or first ignition position
12—Ignition conveying system #2 or second ignition conveying system
12-1—Line A or first line pre-ignition waiting position
12-2—Line B or second line post-ignition stacking position
12-3—Ignition position #2 or second ignition position
13—Sinter boxes
13-1—Line A or first line sintering position
13-2—Line B or second line sintering position
14—Air chamber
15—Coarse dust collector
16—Air pipeline
17—Main air pipeline
18—Main chimney
19—Main air Fan
20—Main fine dust collector
21—Second fine dust collector
22—Second air Fan for dust collection
23—Air pipeline for ignition
24—Air Fan for ignition
25—Second chimney for dust collection

Below is an embodiment of the present disclosure described on the basis of the drawings.

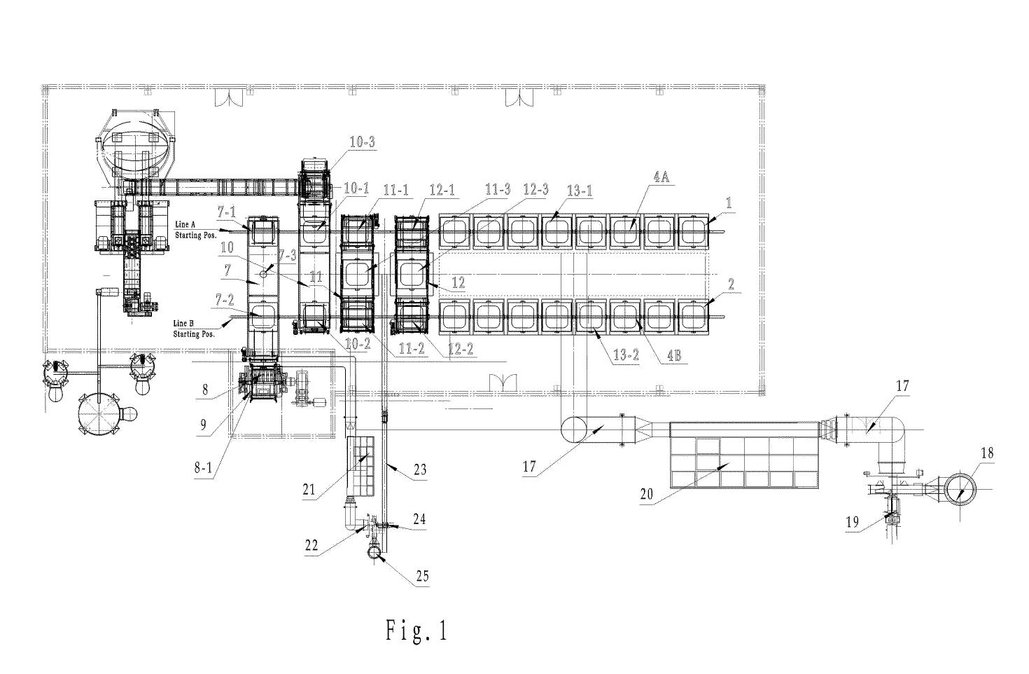

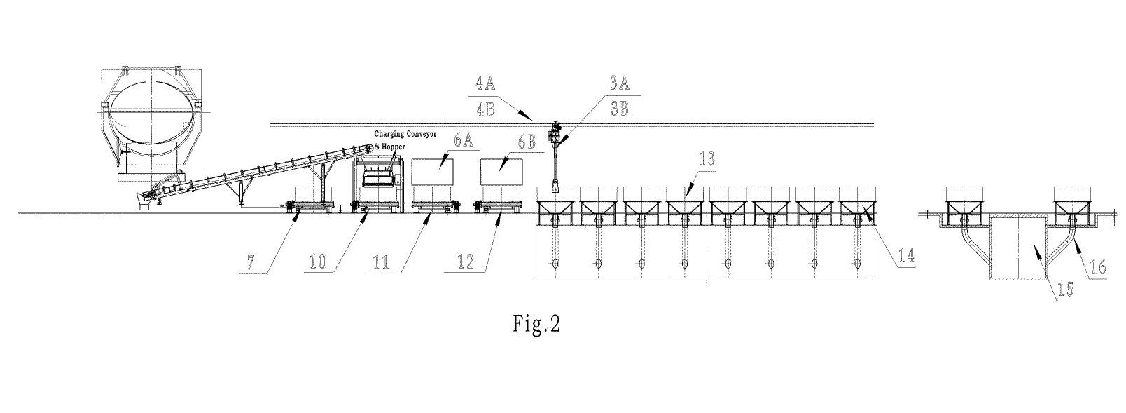

As FIG. 1 and FIG. 2 show, the box-type sintering stacking line A (1) and the box-type sintering stacking line B (2) are arranged in parallel. The sintering stacking lines comprise multiple air chambers (FIG. 1 shows eight sintering positions on each sintering stacking line). The sinter boxes (13) are square, and located on the air chamber (14), under which there is the air pipeline (16) directly connected to the coarse dust collector (15). The box-type sintering stacking line A and the box-type sintering stacking line B share one coarse dust collector (15). Above each sintering stacking line, there are the sinter boxes workstation gantry crane and overhead rails, namely, line A sinter boxes workstation gantry crane (3A) and overhead rail (4A), as well as line B sinter boxes workstation gantry crane (3B) and overhead rail (4B).

The charging and discharging parts of the traditional sintering machine are located on their two ends respectively, while the charging, ignition and discharging positions of the present disclosure are arranged on one end of the sintering stacking line. The ignition conveying system #1 (11) and ignition conveying system #2 (12) are deployed to achieve the movement of sinter boxes necessary for ignition. The ignition station #1 (6A) and ignition station #2 (6B) are respectively located in the middle of ignition conveying system #1 (11) ignition conveying system #2 (12). Two ignition conveying systems are arranged in parallel, for alternate sintering ignition of line A and B.

The charging/discharging conveying system and ignition conveying system are arranged in parallel. The conveyance of sinter boxes between the conveying systems is achieved through the workstation gantry cranes overhead the two sintering stacking lines. Therefore, the two sinter boxes workstation gantry crane rails cross four conveying systems and sintering stacking lines, enabling each workstation gantry crane to address the conveyance among the discharging, post-charging, ignition and sintering positions on the sintering stacking line.

As FIGS. 1 and 2 show, in order to reduce the times of conveyance of workstation gantry cranes in each cycle, the discharging conveying system is arranged on the outside of the charging conveying system. In order that the ignited sinter boxes are conveyed onto the sintering stacking line as quickly as possible, the ignition conveying systems are arranged on the air chamber nearby the sintering stacking line. To meet the requirements of the sintering cycle, the ignition conveying system is designed with one direction operation, while the charging and discharging conveying system are designed with two opposite directions operation.

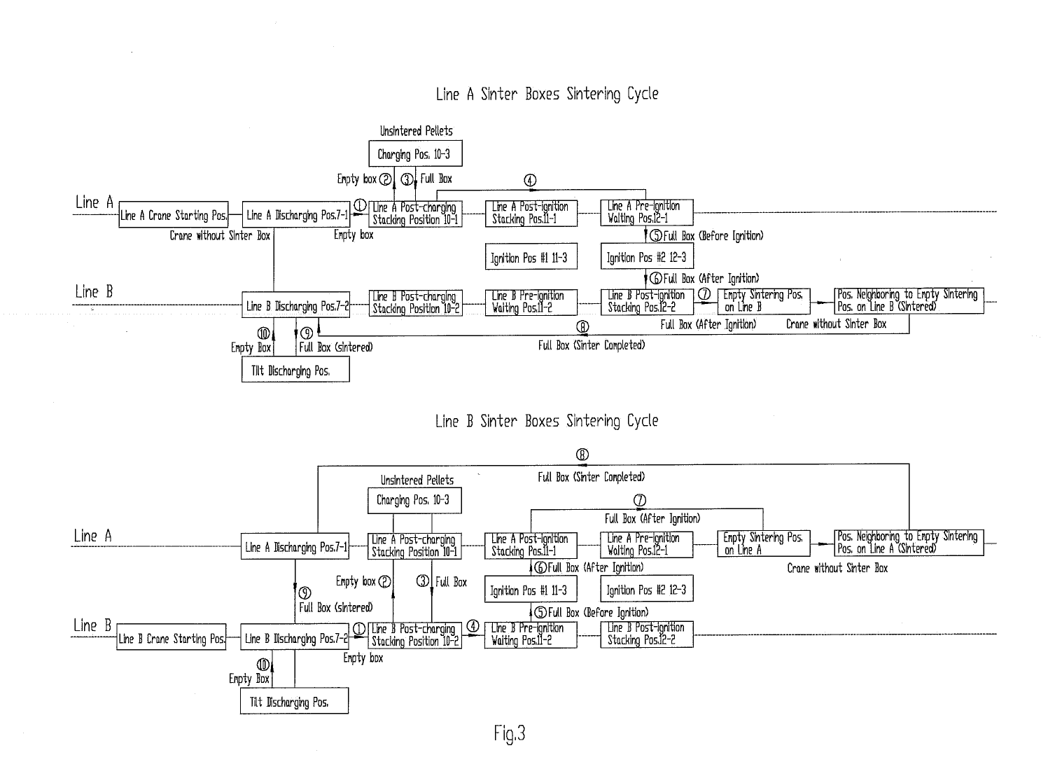

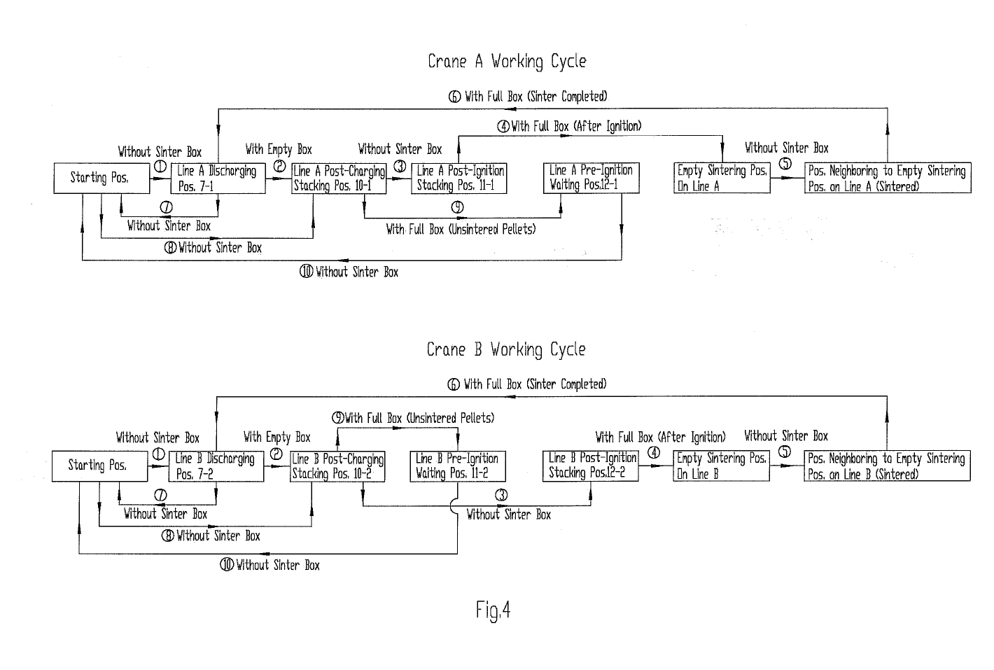

The sinter boxes and cranes in the sintering cycle system follow the cycle sequence shown on FIGS. 3 and 4. FIG. 4 provides the cycle sequence of cranes only, and their start time and relative connection sequence are provided on Table 1. According to FIG. 3, FIG. 4 and Table 1, PLC control program may be accomplished for the cranes or even the entire cycle system.

In Particular, the Cycle Method is as Follows:

The sinter boxes fully charged with unsintered pellets on Line A post-charging stacking position (10-1) are conveyed to line A pre-ignition waiting position (12-1) by line A workstation gantry cranes (3A). After displacement via the ignition conveying system #2 (12) and ignition via the ignition station #2 (6B), the sinter boxes will be sintering on line B;

After the sintering on line B and conveyance through line B workstation gantry cranes (3B) to the discharging conveying system (7) for discharging, the empty sinter boxes are fully charged with unsintered pellets, return to Line A post-charging stacking position (10-2), and are conveyed to line A pre-ignition waiting position (11-2);

The sinter boxes fully charged with unsintered pellets on Line B post-charging stacking position (10-2) are conveyed to line B pre-ignition waiting position (11-2) by line B workstation gantry cranes (3B). After displacement via the ignition conveying system #1 (11) and ignition via the ignition station #1 (6A), they will be sintering on line A;

After the sintering on line A and conveyance through line A workstation gantry cranes (3A) to the discharging conveying system (7) for discharging, the empty sinter boxes are fully charged with unsintered pellets, return to Line B post-charging stacking position (10-1), and are conveyed to line B pre-ignition waiting position (12-1), thus completing a cycle.

The interaction and intersection between line A and B are conducted in certain sequence and under certain conditional restrictions, but the cycle sequences of the transactions are not exclusive. As the basic cycle characteristics are provided, the cycle sequence may be adjusted.

As FIGS. 1 and 3 shows, the sintering cycle includes the following technical steps:

Charging: the ith sinter box to be charged is conveyed via the charging conveying systems (10) to the unsintered pellets charging position (10-3), and be charged in 100 to 300 s, it is conveyed via the charging conveying systems (10) to line A post-charging stacking position (10-1);

Ignition: the overhead workstation gantry cranes (3A) above the sintering stacking line A convey the sinter box from line A post-charging stacking position (10-1) to line A pre-ignition waiting position (12-1), and to ignition position #2 (12-3) via the ignition conveying system #2 (12); after the ignition of the ignition station #2 (6B) in approximately 200 to 500 s, the sinter box is conveyed through the ignition conveying system #2 (12) to line B post-ignition stacking position (12-2);

Sintering: line B overhead workstation gantry cranes (3B) convey the ignited sinter box in line B post-ignition stacking position (12-2) to the sintering stacking line B for sintering for 30-90 min.

Discharging: Line B overhead workstation gantry cranes (3B) convey the sintered sinter box to the discharging position (7-2) of the current sintering stacking line, and the discharging conveying system (7) translates the sintered sinter box to the tilt discharging position (8-1), which turns over the sinter box with the tilt discharger (8) for discharging; the empty sinter box after discharging returns to line A discharging position (7-1) or empty box transition position (7-3).

Here, the sintering cycle includes the transverse displacement of the sinter boxes between two sintering stacking lines. That is, the ignited line A sinter box transversely moves from line A pre-ignition waiting position to line B post-ignition sintering position. Such an across sintering cycle removes the empty boxes return route phenomenon required in the straight-line sintering cycle, but still provides a discharging, ignition, sintering and discharging loop route, thus enabling the PLC fully automatic production, considerably improving the degree of automation of the production line, and raising the production capacity and efficiency of each production line.

As FIG. 3 shows, the cycle steps of line A sinter boxes on the sintering stacking line are as following:

Charging: line A overhead workstation gantry cranes (3A) move forward line A empty sinter box from the starting position to line A discharging position (7-1), to convey the empty sinter box above this position to line A post-charging stacking position (10-1); the charging chain moves forward to translate the empty box from Line A post-charging stacking position (10-1) to the unsintered pellets charging position (10-3) for charging; after charging, the sinter box moves on the charging chain in the reverse direction and returns to line A post-charging stacking position (10-1);

Ignition: line A overhead workstation gantry cranes (3A) convey the fully charged sinter box from line A post-charging stacking position (10-1) to line A pre-ignition waiting position (12-1), and the ignition conveying system #2 (12) moves the fully charged sinter box to the ignition position #2 (12-3) for ignition; line A overhead workstation gantry cranes return to the starting position;

Sintering: line A overhead workstation gantry cranes (3A) move forward from Line A post-ignition stacking position (11-1) to convey the ignited sinter box to line A empty sintering position for sintering;

Discharging: line A overhead workstation gantry cranes (3A) move forward from the empty sintering position to its neighbor to convey the sintered box on line A to line A discharging position (7-1), and the discharging conveying system (7) translates the sintered box to the tilt discharging position (8-1), the sintered box is turned over by the tilt discharger (8) for discharging, and the empty sinter box returns to line B discharging position (7-2) or empty box transition position (7-3);

The sintering cycle steps of the sinter box are: charging—ignition—sintering—discharging—charging.

As FIG. 3 shows, the cycle steps of line B sinter box on the sintering stacking line are as following:

After line A overhead workstation gantry cranes (3A) start to run from the starting position for 30 to 200 s, the cycle sintering steps on the box-type sintering stacking line B run simultaneously as following:

Charging: line B overhead workstation gantry cranes (3B) move forward from the starting position on line B the empty sinter box to the discharging position (7-2), conveying the empty sinter box to Line B post-charging stacking position (10-2), and the charging chain (10) translates the empty box from Line B post-charging stacking position (10-2) to the unsintered pellets charging position (10-3) for charging; the fully charged sinter box returns to line B post-charging stacking position (10-2);

Ignition: line B overhead workstation gantry cranes (3B) convey the fully charged sinter box from line B post-charging stacking position (10-2) to the pre-ignition waiting position (11-2) on line B, and the ignition conveying system #1 (11) translates the fully charged sinter box to the ignition position #1 (11-3) for ignition, and line B overhead workstation gantry cranes return to the starting position;

Sintering: line B overhead workstation gantry cranes (3B) move from Line B post-ignition stacking position (12-2) to convey the ignited sinter box to line B empty sintering position for sintering;

Discharging: line B overhead workstation gantry cranes (3B) move forward from the empty sintering position to its neighbor to convey the sintered box on line B to line B discharging position (7-2), and the discharging conveying system (7) translates the sintered box to the tilt discharging position (8-1), the sintered box is turned over by the tilt discharger (8) for discharging, the empty sinter box returns to line A discharging position (7-1) or empty box transition position (7-3);

The sintering cycle steps of the sinter box are: charging—ignition—sintering—discharging—charging.

Table 1 gives the program control logic process of the across cycle for various cranes during sinter cycle.

As FIGS. 1 and 4 and Table 1 shows, the cycle processes of various devices in the sintering cycle are as follows:

Line A overhead workstation gantry cranes (3A):

As FIG. 4 shows, cranes (3A) move forward empty sinter box from the starting position to discharging position (7-1) on line A, to convey the empty box (A1) to post-charging stacking position (10-1), and then continue to move forward empty sinter box to convey the sinter box (A2) on post-ignition stacking position (11-1) to the empty sintering position; then move forward empty sinter box to its neighbor to convey the sintered box (A3) back to line A discharging position (7-1), then moving back to the starting position empty sinter box. When the sinter box (A4) is fully charged with unsintered pellets and returned to Line A post-charging stacking position (10-1), the cranes continue to move forward to Line A post-charging stacking position (10-1) to convey the sinter box (A4) to line A pre-ignition waiting position (12-1), and then cranes (3A) return to the starting position without sinter box.

Line B overhead workstation gantry cranes (3B) (at the same time when line A acts as described above):

As FIG. 4 shows, after line A overhead workstation gantry cranes (3A) move from the starting position to discharging position on line A (7-1) convey the empty box (A1) to line A charging position (10-1), line B cranes (3B) move forward empty sinter box from starting position to post-charging stacking position (10-2), to convey the fully charged sinter box (B4) to line B pre-ignition waiting position (11-2), and then the cranes (3B) return to the starting position empty sinter box; when the empty sinter box (B1) comes from the previous cycle to line B discharging position (7-2), the crane moves forward empty sinter box from the starting position to line B discharging position (7-2) to convey the empty sinter box (B1) to line B post-charging stacking position (10-2), and then continues to move forward to line B post-ignition stacking position (12-2), to convey the ignited sinter box (B2) to the empty sintering position, then move forward without sinter box to its neighbor to convey the sintered box (B3) back to line B discharging position (7-2), then moving back to the starting position empty sinter box for next cycle.

Charging Conveying System:

As FIG. 1 shows, after conveyed by cranes (3A) to the post-charging stacking position (10-1), the empty box (A1) on line A translates to charging position (10-3) to charge for approximately 100 to 300 s, the fully charged sinter box is then conveyed from the charging position (10-3) back to Line A post-charging stacking position (10-1); after the fully charged box is hoisted and moved by cranes (3A) and the empty box is on the line B post-charging stacking position (10-2), the charging conveying systems (10) runs in the reverse direction to move the empty box from line B post-charging stacking position (10-2) to the charging position (10-3) for charging; the fully charged box then moves back to line B post-charging position (10-2)

Discharging Conveying System:

As FIG. 1 shows, the sintered box conveyed to line B discharging position (7-2), and the discharging conveying system (7) moves the box to the tilt discharging position (8-1) for tilt discharging, after which, the empty sinter box returns to the horizontal position, and is conveyed through the discharging conveying system (7) to line A discharging position (7-1) for next step.

Ignition Conveying System:

As FIG. 1 shows, the ignition conveying system #1 (11) moves the fully charged sinter box from line B pre-ignition waiting position (11-2) to ignition position #1 (11-3) for ignition by ignition station #1 (6A) for approximately 200 to 500 s, and the ignited sinter box moves to line A post-ignition stacking position (11-1). The ignition conveying system #2 (12) acts similarly.

The above embodiment is aim to provide one specific implementation mode of present disclosure, and the protection scope of this application is not limited to that of the embodiment.

TABLE 1
The program control logic process for across cycle of the cranes.

| Crane A Working Cycle | steps | Cranes B Working Cycle | steps |
|---|---|---|---|
| Move forward from the starting position | 1 | Move forward from the starting | 8 |
| to discharging position (7-1) (cycle | | position to post-charging | |
| starts) | | stacking position (10-2) | |
| Moves forward to convey the empty box | 2 | Conveys the fully charged sinter | 9 |
| to post-charging stacking position (10-1) | | box from post-charging stacking | |
| | | position (10-2) to pre-ignition | |
| | | waiting position (11-2) | |
| | | Moves back from pre-ignition | 10 |
| | | waiting position (11-2) to | |
| | | starting position | |
| Move forward from post-charging | 3 | | |
| stacking position (10-1) to post-ignition | | | |
| stacking position (11-1) | | | |
| Move forward from post-ignition | 4 | | |
| stacking position (11-1) to empty | | | |
| sintering position | | | |
| Move forward from empty sintering | 5 | | |
| position to its neighbor | | | |
| Move back from neighboring position to | 6 | | |
| discharging position (7-1) | | | |
| | | Move back from discharging | 7 |
| | | position (7-2) to the starting | |
| | | position | |
| Go back Step 1 for next cycle | | Go back to step 8 for next cycle | |

The purpose of the present disclosure is to provide a kind of box-type sintering cycle apparatus, remove the arc connections of equipment, improve the operating stability, and enhance the production efficiency.

Another purpose of the present disclosure is to provide a kind of box-type sintering cycle method, which resolves the long-standing issues of equipment waste and low efficiency associated with all sintering machines that return the empty sintering carts or boxes to the starting position following discharge, while improving output, reducing the amount of equipment needed and related investment.

To achieve the purposes, the present disclosure is implemented as follows:

A kind of box-type sintering cycle apparatus comprising a plurality of sinter boxes arranged on the box-type sintering stacking lines, with air chamber under the sinter boxes and ignition system above the sintering stacking lines, wherein there are at least two parallel box-type sintering stacking lines (1, 2), above which the crane rails and cranes enable the sinter boxes to hoist and move;

Above each of the parallel box-type sintering stacking lines arrange a post-charging stacking position, a discharging position, a pre-ignition waiting position, a post-ignition stacking position and multiple sintering positions respectively, which are all arranged on a straight line; the post-charging stacking position (10-1, 10-2), discharging position (7-1, 7-2), pre-ignition waiting position (11-2, 12-1) and post-ignition stacking position (11-1, 12-2) are located on the same end of the sintering stacking line or may be distributed at any locations on the sintering stacking line;

Above the parallel box-type sintering stacking lines are the workstation gantry crane rails crossing all said positions, namely, the post-charging stacking position, discharging position, pre-ignition waiting position, post-ignition stacking position and a plurality of sintering positions; the crane systems are adopted for overhead conveyance of the sinter boxes along the sintering stacking lines; multiple conveying systems are deployed for the sinter boxes between the parallel box-type sintering stacking lines to accomplish their transverse displacement, and the conveying systems are parallel to each other but vertical to the sintering stacking lines.

The sequence of the post-charging stacking position, discharging position, pre-ignition waiting position and post-ignition stacking position is changeable.

The multiple conveying systems comprise the charging conveying system (10), discharging conveying systems (7), ignition conveying system #1 (11) and ignition conveying system #2 (12).

The conveying systems adopt the mechanism of sprockets/chains or rollers.

The charging conveying system (10) is designed with three positions, i.e., unsintered pellets charging position (10-3), line A post-charging stacking position (10-1) and line B post-charging stacking position (10-2).

The discharging conveying system (7) is designed with 1) two positions, i.e., line A discharging position (7-1) and line B discharging position (7-2); or 2) three positions, i.e., the operating program may be modified to add one empty box transition position (7-3).

The ignition conveying system #1 (11) is designed with three positions, i.e., line A post-ignition stacking position (11-1), line B pre-ignition waiting position (11-2) and ignition position #1 (11-3).

The ignition conveying system #2 (12) is designed with three positions, i.e., line

A pre-ignition waiting position (12-1), line B post-ignition stacking position (12-2) and ignition position #2 (12-3).

The ignition system comprises alternatively working ignition station #1 (6A) and ignition station #2 (6B), which are respectively located above the ignition positions (11-3, 12-3) between the two sintering stacking lines.

The crane system comprises the crane rails (4A, 4B) and the overhead workstation gantry cranes (3A, 3B).

Each of the two sintering stacking lines has a pre-ignition waiting position and a post-ignition stacking position, and both pre-ignition waiting positions (11-2, 12-1) and both post-ignition stacking positions (11-1, 12-2) are located on the two sintering stacking lines in the reverse sequence.

The parallel sintering stacking lines share one coarse dust collector (15), with each sinter box located on the air chamber (14), under which there is the air chamber pipeline (16) connected to the coarse dust collector.

The discharging conveying system (7) is located next to the charging conveying system (10), or on the other end of the sintering stacking line. The charging conveying system (10) and discharging conveying system (7) run in both directions.

Both ignition conveying systems run in one direction respectively: the ignition conveying system #1 (11) and ignition conveying system #2 (12) run in opposite directions; the positions of the conveying system #1 and #2 are exchangeable.

There are 3˜30 sinter boxes (13) on each line.

Sintering cycle method of a kind of box-type sintering machine, comprising the charging, ignition, sintering and discharging steps, wherein:

There are two parallel sintering stacking lines: sintering stacking line A (1) and sintering stacking line B (2), with the sinter boxes between both sintering stacking lines providing the following basic cyclic features:

After charging and ignition on line A, the sinter boxes of line A transversely translate to line B for sintering, and after the discharging is finished on line B upon the sintering, the sinter boxes return to the discharging/charging position for charging next time;

After charging and ignition on line B, the sinter boxes of line B transversely translate to line A for sintering, and after the discharging is finished on line A upon the sintering, the sinter box returns to the discharging/charging position for charging next time, thus completing a cycle;

The discharging/charging position is one selected from line A discharging position (7-1), line B discharging position (7-2) and line A/B charging position (10-2).

The sinter boxes on each sintering stacking line enter the sintering stacking line to finish the sintering and discharging, then the empty sinter boxes returns to the charging position of the current sintering stacking line for charging.

The coordination for the equipment of each sintering stacking line meet the cycle as one of the following conditions: 1) when crane A at the starting position on line A moves forward to line A discharging position (7-1), crane B at the starting position on line B moves forward to line B post-charging stacking position (10-2); 2) when crane B at the starting position on line B moves forward to line B discharging position (7-2), crane A at the starting position on line A moves forward to line A post-charging stacking position (10-1).

The cranes (3A, 3B) convey the sinter box along the sintering stacking lines (1, 2), and multiple conveying systems accomplish the transverse displacement of the sinter boxes between the two sintering stacking lines.

The cranes convey the sinter boxes along the sintering stacking line to accomplish the following processes:

1) Conveying without carrying sinter box from starting position to discharging position (7-1, 7-2);

2) Conveying empty sinter box from discharging position (7-1, 7-2) to post-charging stacking position (10-1, 10-2);

3) Conveying without carrying sinter box from post-charging stacking position (10-1, 10-2) to post-ignition stacking position (11-1, 12-2);

4) Conveying the sinter box after being ignited from post-ignition stacking position (11-1, 12-2) to the empty sintering position;

5) Conveying without carrying sinter box from empty sintering position to its neighbor;

6) Conveying the sinter box after sintered from the neighbor to discharging position (7-1, 7-2);

7) Conveying without carrying sinter box from discharging position (7-1, 7-2) back to the starting position;

8) Conveying without carrying sinter box from the starting position to post-charging stacking position (10-1, 10-2);

9) Conveying the sinter box filled with unsintered pellets from the post-charging stacking position (10-1, 10-2) to pre-ignition waiting position (12-1, 11-2);

10) Conveying without carrying sinter box from pre-ignition waiting position (12-1, 11-2) back to the starting position to finish one sintering cycle.

Between the processes 2) and 9), the empty sinter box accomplishes the transverse displacement from post-charging stacking position (10-1, 10-2) to the unsintered pellets charging position (10-3) through the charging conveying system (10).

Between the processes 7) and 10), the crane returns from discharging position (7-1, 7-2) and the pre-ignition waiting position (12-1, 11-2,) back to the starting position.

Between the processes 2) and 3), the ignition conveying systems (11, 12) accomplishes the transverse displacement of the sinter box from the pre-ignition waiting position (12-1, 11-2) to the ignition position (11-3, 12-3), and then to the post-ignition stacking position (12-2, 11-1).

After the process 6), the tilt discharger (8) accomplishes the discharging of the sinter box.

After the process 7), the discharging conveying system (7) accomplishes the transverse displacement of the sinter box between the two sintering stacking lines.

The present disclosure adopts two straight sintering lines, whose delicate arrangement of both discharging and charging on the same end implements the possibilities and advantages of box-type sintering. It uses the sinter boxes on both lines for cross charging, discharging, ignition and conveyance, without any separate return loop, thus resolving the long-standing issues of equipment waste and low efficiency associated with all sintering machines that return the empty sintering carts or boxes to the starting position following discharge. Also, it uses the technologies described in the same applicant's Chinese invention patent application (title: Ignition method and apparatus of product line for sintering porcelain granule, application number: 200810097540.0) and Chinese utility model patent (title: Sintering box for plane circulatory sintering, patent number: ZL2006 2 0001922.5), making full use of the box-type sintering and at the same time overcoming the defects of box-type sintering. The contents of the above applications are incorporated herein by reference in their entireties.

The sintering cycle system of the present disclosure comprises the following several sub-systems: two straight and parallel sintering stacking lines (1, 2), a plurality of sinter boxes (3 to 30) on each line, air chamber under each sinter box, air pipeline under the air chamber connected to the coarse dust collector, and sinter boxes workstation gantry crane and overhead rails above each sintering stacking line. The system also includes four conveying systems, two ignition stations, one tilt discharger, and one crusher. The two conveying systems are used to move the sinter boxes from the pre-ignition waiting position to ignition position, while moving the ignited sinter boxes to the post-ignition stacking position. One conveying system is used for charging, i.e., moving the empty sinter boxes to the unsintered pellets charging position (10-3), and it is also used for moving the fully charged sinter boxes right under the crane conveyance tracks, namely, line A post-charging stacking position (10-1) or line B post-charging stacking position (10-2). The other conveying system is used for discharging, i.e., moving the post-sintering sinter boxes to the tilt discharger for discharging. It is also used to convey the discharged empty sinter boxes right under the workstation gantry crane rails, namely, line A discharging position (7-1) or line B discharging position (7-2). The tilt discharger (8) is for discharging the sinter boxes after sintering, usually for tilt discharging, after which, it conveys the empty sinter boxes back to the discharging conveying system (7). The crusher (9) is used to crush the big pellets formed in the process of sintering.

For the electrical ignition technology of the present disclosure, please refer to the ignition device of sintering system described in the applicant's Chinese invention patent application titled “Ignition method and apparatus of product line for sintering porcelain granule” (application number: 200810097540.0, date of application: May 12, 2008), which is simple and of low operating cost. The content of the above application is incorporated herein by reference in its entirety. In order to ensure the stability of ignition air, the separate air chamber is adopted for the ignition system.

The system also includes the fine dust collector, a main air inductor, main air pipelines, chimney and other devices included in the traditional sintering systems. Additionally, in order to control the dust generated in the process of production, the system may be configured with a second dust collection system, which is mainly for the control of dust generated during the discharging. It comprises the second fine dust collector, a second air inductor, chimney and pipeline.

In the Present Disclosure:

Line A discharging position (7-1): is the intersection at line A and discharging conveying system (7).

Line B discharging position (7-2): is the intersection at line B and discharging conveying system (7).

Unsintered pellets charging position (10-3): is the position for charging the empty sinter boxes on the charging conveying system (10).

Line A post-charging stacking position (10-1): is the intersection at line A and charging conveying system (10).

Line B post-charging stacking position (10-2): is the intersection at line B and charging conveying system (10).

Line A pre-ignition waiting position (12-1): is the intersection at line A and ignition conveying system #2 (12).

Line A post-ignition stacking position (11-1): is the intersection at line A and ignition conveying system #1 (11).

Line B pre-ignition waiting position (11-2): is the intersection at line B and ignition conveying system #1 (11).

Line B post-ignition stacking position (12-2): is the intersection at line B and ignition conveying system #2 (12).

Ignition position #1 (11-3): is the middle position of the ignition conveying system #1 (11).

Ignition position #2 (12-3): is the middle position of the ignition conveying system #2 (12).

Empty box transition position (7-3): is located in the middle of the discharging conveying system (7), for caching the empty boxes discharged.

Compared with the present technologies, the present disclosure provides one or more of the following benefits:

The sintering method of the present disclosure changes the traditional dynamic and mobile sintering into the static sintering, considerably improving the air leakage and reducing the energy consumption by approximately 30 to 45%.

Electrical ignition is adopted to cut down the manufacturing and operating cost of ignition device, and it is helpful for environmental protection, and easy to implement.

Box-type sintering is adopted, and so is the utility model titled “Sintering box for plane circulatory sintering” (patent number: ZL2006 2 0001922.5), which improves the quality uniform of product on the internal edge and in the center of the sinter boxes, thus achieving high finished product ratio. The content of the above application is incorporated herein by reference in its entirety.

The various sub-systems in the cycle system of the present disclosure feature simple equipment structure. Many devices adopt the same structure, thus reducing the manufacturing cost and enable high operating reliability.

The sintering machine of the present disclosure is designed with a compact structure, enabling small installation space and easy maintenance.

Compared with the traditional sintering machines, it considerably saves the steel consumption, and features lower requirements for manufacturing and installation precision. Compared with the traditional sintering machines of the same production capacity, it maintains simple equipment, and lower price, which is ⅕˜½ of that of the traditional equipment. Also, its operating cost is lower, i.e., approximately 60% of that of the traditional equipment.

Finally, the foregoing description is not a definition of the invention, but is a description of one or more examples of exemplary embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of exemplary embodiments disclosed herein, but instead is defined solely by the claims below.

What is claimed is:

1. A box-type sintering cycle apparatus comprising:
a plurality of sinter boxes arranged on box-type sintering stacking lines, with air chambers under the sinter boxes and an ignition system above the sintering stacking lines, wherein there are at least two parallel box-type sintering stacking lines, above which crane rails and cranes enable the sinter boxes to hoist and move;
above each of the parallel box-type sintering stacking lines is arranged a post-charging stacking position, a discharging position, a pre-ignition waiting position, a post-ignition stacking position, and multiple sintering positions, which are all arranged on a straight line, and the post-charging stacking position, discharging position, pre-ignition waiting position and post-ignition stacking position are located on the same end of the sintering stacking line or may be arranged at any locations on the sintering stacking lines;
above the parallel box-type sintering stacking lines are workstation gantry crane rails crossing all said positions, namely, the post-charging stacking position, discharging position, pre-ignition waiting position, post-ignition stacking position, and multiple sintering positions;
overhead workstation gantry cranes are adopted for conveyance of the sinter boxes along the sintering stacking lines;
multiple conveying systems are deployed for the sinter boxes transferring between the parallel box-type sintering stacking lines; and
the conveying systems are parallel to each other but vertical to the sintering stacking lines.

2. The apparatus of claim 1, wherein a sequence of the post-charging stacking position, discharging position, pre-ignition waiting position, and post-ignition stacking position is changeable.

3. The apparatus of claim 1, wherein the multiple conveying systems comprise a charging conveying system, discharging conveying systems, a first ignition conveying system and a second ignition conveying system.

4. The apparatus of claim 3, wherein the conveying systems adopt the mechanism of sprockets/chains or rollers.

5. The apparatus of claim 3, wherein the charging conveying system is designed with the following three positions: unsintered pellets charging position, a first line post-charging stacking position, and a second line post-charging stacking position.

6. The apparatus of claim 3, wherein the discharging conveying system is designed with at least two positions including a first line discharging position, and a second line discharging position and, optionally, three positions wherein the operating control program may be modified to add one empty box transition position.

7. The apparatus of claim 3, wherein the first ignition conveying system is designed with three positions including a first line post-ignition stacking position, a second line pre-ignition waiting position and a first ignition position.

8. The apparatus of claim 3, wherein the first ignition conveying system is designed with three positions including a first line pre-ignition waiting position, a second line post-ignition stacking position and a second ignition position.

9. The apparatus of claim 1, wherein the ignition system comprises alternately working first ignition station and second ignition station, which are respectively located above the ignition positions between the two sintering stacking lines.

10. The apparatus of claim 1, wherein the workstation gantry crane system comprises rails and overhead workstation gantry cranes.

11. The apparatus of claim 1, wherein each of the two sintering stacking lines has a pre-ignition waiting position and a post-ignition stacking position, and both pre-ignition waiting positions and both post-ignition stacking positions are located on the two sintering stacking lines in the reverse sequence.

12. The apparatus of claim 1, wherein the parallel sintering stacking lines share one coarse dust collector, with each sinter box located on each air chamber, under which there is an air pipeline connected to the coarse dust collector.

13. The apparatus of claim 1, wherein the discharging conveying system is located on the side of the charging conveying system, or on the other end of the sintering stacking line; and wherein the charging conveying system and discharging conveying system run in both directions.

14. The apparatus of claim 1, wherein each ignition conveying system run in one direction, the first ignition conveying system and second ignition conveying system run in opposite direction respectively, and wherein the positions of the first and second ignition conveying systems are exchangeable.

15. The apparatus of claim 1, wherein there are 3 to 30 sinter boxes on each sintering stacking line.

16. A sintering cycle method for a box-type sintering machine, comprising:
charging, ignition, sintering and discharging steps, wherein there are two parallel sintering stacking lines including a sintering stacking first line and a sintering stacking second line, with sinter boxes between both sintering stacking lines providing the following basic cyclic features:
after charging and ignition on the first line, the sinter boxes of the first line transversely translate to the second line for sintering, and after the discharging is finished on the second line upon the sintering, the sinter boxes return to a discharging/charging position for charging next time;
after charging and ignition on the second line, the sinter boxes of the second line transversely translate to the first line for sintering, and after the discharging is finished on the first line upon the sintering, the sinter boxes return to the discharging/charging position for charging next time, thus completing a cycle;
the discharging/charging position is one selected from a first line discharging position, a second line discharging position, and first and second lines charging position.

17. The method of claim 16, wherein the sinter boxes on each sintering stacking line enter the sintering stacking line to finish the sintering and discharging, then empty sinter boxes returns to the charging position of the current sintering stacking line for charging.

18. The method of claim 16, wherein the coordination for the equipment of each sintering stacking line meet the cycle as one of the following conditions:
1) when a first crane at the starting position on the first line moves forward to the first line discharging position, a second crane at the starting position on the second line moves forward to a second line post-charging stacking position;
2) when the second crane at the starting position on the second line moves forward to the second line discharging position, the first crane at the starting position on the first line moves forward to a first line post-charging stacking position.

19. The method of claim 16, wherein the cranes convey the sinter boxes along the sintering stacking lines, and multiple conveying systems accomplish the transverse displacement of the sinter boxes between the two sintering stacking lines.

20. The method of claim 16, wherein the cranes convey the sinter boxes along the sintering stacking line to accomplish the following processes:
1) conveying without carrying the sinter boxes of the sinter boxes from starting position to discharging position;
2) conveying empty the sinter boxes from discharging position to post-charging stacking position;
3) conveying without carrying the sinter boxes from post-charging stacking position to post-ignition stacking position;
4) conveying the sinter boxes after being ignited from post-ignition stacking position to the empty sintering position;
5) conveying without carrying the sinter boxes from empty sintering position to its neighbor;
6) conveying the sinter boxes after sintered from the neighbor to discharging position;
7) conveying without carrying the sinter boxes from discharging position back to the starting position;
8) conveying without carrying the sinter boxes from the starting position to post-charging stacking position;
9) conveying the sinter boxes filled with unsintered pellets from the post-charging stacking position to pre-ignition waiting position;
10) conveying without carrying the sinter boxes from pre-ignition waiting position back to the starting position to finish one sintering cycle.

21. The method of claim 20, wherein between the processes 2) and 9), the empty sinter boxes accomplish the transverse displacement from post-charging stacking position to the unsintered pellets charging position through the charging conveying system.

22. The method of claim 20, wherein between the processes 7) and 10), the crane returns from discharging position and the pre-ignition waiting position back to the starting position.

23. The method of claim 20, wherein, between the processes 2) and 3), the ignition conveying systems accomplishes the transverse displacement of the sinter boxes from the pre-ignition waiting position to the ignition position, and then to the post-ignition stacking position.

24. The method of claim 20, wherein, after the process 6), the tilt discharger (8) accomplishes the discharging of the sinter box.

25. The method of claim 20, wherein, after the process 7), the discharging conveying system accomplishes the transverse displacement of the sinter boxes between the two sintering stacking lines.
